(19) United States
(12) Patent Application Publication
(10) Pub. No.: US 2021/0383476 A1
(43) Pub. Date: Dec. 9, 2021

(54) CORE RATE GENERATION APPARATUS, CORE RATE GENERATION METHOD, AND PROGRAM THEREOF

(71) Applicant: Rakuten Group Inc., Tokyo (JP)

(72) Inventors: Matthew AMES, Tokyo (JP); Bruno Andre CHARRON, Tokyo (JP)

(73) Assignee: Rakuten Group Inc., Tokyo (JP)

(21) Appl. No.: 17/055,828

(22) PCT Filed: Oct. 31, 2019
(86) PCT No.: PCT/JP2019/042745

§ 371 Date: Nov. 16, 2020

(51) Int. Cl. G06Q 40/06

(52) U.S. Cl. CPC G06Q 40/06

(57) ABSTRACT

Disclosed herein is a core rate generating apparatus (1), comprising: a rate acquiring unit (12) configured to acquire a plurality of rates respectively generated by a plurality of counterparties; a median value calculation unit (13) configured to calculate a median value of whole of the plurality of rates of the plurality of counterparties; a difference calculation unit (13) configured to calculate a first difference between each of the plurality of rates and the median value for each of the plurality of counterparties; a weight deriving unit (14) configured to derive, based on the first difference, a weight for each of the plurality of counterparties; and a core rate generation unit (15) configured to apply, for each of the plurality of counterparties, the weight to each of the rates and generate a core rate.

### TECHNICAL FIELD

The present invention relates to a core rate generation apparatus, a core rate generation method, and a program thereof, and more particularly, to a technique for automatically generating a core rate, which is a basis of a rate to be presented to a customer, from a plurality of rates presented by a plurality of counterparties.

### BACKGROUND ART

A business operator that conducts financial transactions based on, for example, exchange rates, such as Foreign Exchange Margin Transactions (FX), offers to customers (i.e., investors) as needed selling prices (BIDs) and buying prices (ASKs) of the business operator on a per-currency-pair basis through a Graphical User Interface (GUI) constructed with a web platform or the like.

Customers open transaction accounts and multiply their own funds by a predetermined leverage (25:1 for Japanese customers) to buy and sell their own funds at the offered buying prices (ASKs) and selling prices (BIDs).

The business operators may earn profits from the spread, which is the difference between ASK and BID, without collecting a separate fee.

For example, assuming that the buying price (ASK) of a certain business operator is 109.947 yen per U.S. dollar and the selling price (BID) is 109.944 yen per U.S. dollar, the spread is 0.003 yen (0.3pips:1pip=1 sen) for the U.S. dollar/Japanese yen (USD/JPY) currency pair.

The business operators offset market risks (i.e., risks associated with market fluctuations) by engaging in buying and selling transactions for hedging positions, which have been incurred to the business operators by negotiation transactions with customers, with a plurality of counterparties, with which the business operators perform covering transactions, (e.g., financial institutions such as banks, or securities companies).

For this reason, in general, a to-be-presented rate to investors, which is presented by the business operator to the customers, is generated based on counterparty-presenting rates, which are presented by the counterparties to the business operator and acquired from a plurality of counterparties, respectively.

More particularly, the business operator monitors the counterparty-presenting rates from a plurality of counterparties and manually selects a subset of would-be reliable counterparties. The business operator then generates a core rate, for example, by using the most recent ASK rate and BID rate that are most advantageous to the business operator, from among the counterparty-presenting rates of the selected subset of counterparties.

This core rate is added with a spread that is profitable to the business operator to generate a spread-added rate. In addition, a skew processing of increasing or decreasing a skew value of an arbitrary margin is applied to the spread to generate the to-be-presented rate to investors, which is to be presented to the customers.

Patent Literature 1 (Laid-open Publication of Japanese Patent Application No. 2014-13516 A) discloses a rate generation system for an OTC (Over The Counter)-FX operation that generates a core rate by acquiring market maker quoted rates that are repeatedly sent from a plurality of counterparties (i.e., market makers) at short time intervals, such as 0.05 to 0.1 second.

More particularly, when the currency pair is U.S. dollar/Japanese yen (USD/JPY), the rate generation system of Patent Literature 1 selects a BID core rate, which is the rate at which the FX merchant can sell the U.S. dollar at the highest price (i.e., a rate quoted by the market maker who buys the U.S. dollar at the highest price) for BID, from a plurality of market maker quoted rates acquired, while for ASK, the rate generation system selects an ASK core rate, which is the rate at which the FX merchant can buy the U.S. dollar at the lowest price (i.e., a rate quoted by the market maker who sells the U.S. dollar at the lowest price).

### LISTING OF REFERENCES

### Patent Literature

PATENT LITERATURE 1: Laid-open Publication of Japanese Patent Application No. 2014-13516 A

### SUMMARY OF THE INVENTION

### Problems to be Solved by the Invention

However, the counterparty-presenting rate of the manually selected subset of counterparties, typically a few counterparties, does not necessarily include the rate that is most favorable to the business operator. For this reason, conventionally, in some cases an optimal core rate cannot be generated for a business operator, and the accuracy of the core rate is likely to be lowered.

In particular, when an inaccurate and anomalously fluctuating rate is presented suddenly from any one of the selected counterparties, if such an inaccurate and anomalously fluctuating rate happens to be the best BID/ASK rate, the eventually generated core rate is directly affected by the anomalous fluctuation of the counterparty-presenting rate.

In addition, the volume of transactions of exchange trading to be performed in the market on a daily basis rises, for example, up to tens of billion US dollars, and the update frequency of the rate is extremely high, for example, 5 ms, resulting in the update of the rate up to several million times per day. For this reason, it is required for the processing of automatically calculating the core rate to be capable of being performed at a higher speed while reducing an increase in the load on the system resources.

The present invention has been made in order to solve the above mentioned problems and an object thereof is to provide a core rate generation apparatus, a core rate generation method and a program thereof that are robust against an anomalous fluctuation incidentally occurring in the rates presented from a plurality of counterparties and are capable of generating a core rate with higher accuracy.

### Solution to Problems

In order to solve the above mentioned problems, according to one aspect of the present invention, there is provided a core rate generating apparatus, comprising: a rate acquiring unit configured to acquire a plurality of rates respectively generated by a plurality of counterparties; a median value calculation unit configured to calculate a median value of whole of the plurality of rates of the plurality of counterparties; a difference calculation unit configured to calculate a first difference between each of the plurality of rates and the median value for each of the plurality of counterparties; a weight deriving unit configured to derive, based on the first difference, a weight for each of the plurality of counterparties; and a core rate generation unit configured to apply, for each of the plurality of counterparties, the weight to each of the rates and generate a core rate.

The core rate generation apparatus may further comprise a mid value calculation unit configured to calculate a mid value of the plurality of rates for each of the plurality of counterparties, and the median value calculation unit may calculate the median value of whole of the mid values of the plurality of counterparties, the difference calculation unit may calculate a second difference between the mid value and the median value for each of the plurality of counterparties, and the core rate generation unit may apply, for each of the plurality of counterparties, the weight to the mid value to generate the core rate.

The core rate generation unit may generate, as the core value, a median value of whole of a plurality of weighted mid values of the plurality of counterparties.

The weight deriving unit may calculate an accuracy value of each of the plurality of counterparties using the second difference between the mid value and the median value as an input to an exponential function, and derive the weight from the accuracy value calculated.

The weight deriving unit may calculate the accuracy value of each of the plurality of counterparties over a predetermined period, and derive the weight based on a plurality of accuracy values calculated.

The weight deriving unit may derive the weight by calculating an exponential moving average of the plurality of the accuracy values calculated over the predetermined period.

The core rate generation apparatus may further comprise a first adjustment unit configured to adjust a first parameter of the exponential moving average using a predetermined evaluation function when deriving the weight from the accuracy values by the weight calculation unit.

The core rate generation apparatus may further comprise a second adjustment unit configured to adjust a second parameter of the exponential function using a predetermined evaluation function when calculating the accuracy value by the weight calculation unit using the second difference as an input to the exponential function.

The core rate generation unit may further generate a rate to be presented to a customer by adding a skew to the generated core rate with a predetermined spread width.

According to another aspect of the present invention, there is provided a core rate generation program for causing a computer to execute core rate generation processing, the program causing the computer to execute processing, comprising: a rate acquiring process for acquiring a plurality of rates respectively generated by a plurality of counterparties; a median value calculation process for calculating a median value of whole of the plurality of rates of the plurality of counterparties; a difference calculation process for calculating a first difference between each of the plurality of rates and the median value for each of the plurality of counterparties; a weight deriving process for deriving, based on the first difference, a weight for each of the plurality of counterparties; and a core rate generation process for applying, for each of the plurality of counterparties, the weight to each of the rates and generating a core rate.

According to yet another aspect of the present invention, there is provided a core rate generation program for causing a computer to execute core rate generation processing, the program causing the computer to execute processing, comprising: a rate acquiring process for acquiring a plurality of rates respectively generated by a plurality of counterparties; a median value calculation process for calculating a median value of whole of the plurality of rates of the plurality of counterparties; a difference calculation process for calculating a first difference between each of the plurality of rates and the median value for each of the plurality of counterparties; a weight deriving process for deriving, based on the first difference, a weight for each of the plurality of counterparties; and a core rate generation process for applying, for each of the plurality of counterparties, the weight to each of the rates and generating a core rate.

### Advantageous Effect of the Invention

According to the present invention, it makes it possible to generate a core rate more accurately that is robust against an anomalous fluctuation incidentally occurring in the rates presented by a plurality of counterparties.

The above-mentioned and other not explicitly mentioned objects, aspects and advantages of the present invention will become apparent to those skilled in the art from the following embodiments (detailed description) of the invention by referring to the accompanying drawings and the appended claims.

### BRIEF DESCRIPTION OF DRAWINGS

FIG. 1 is a block diagram showing an exemplary network configuration of an exchange trading network system according to an embodiment of the present invention.

FIG. 2 is a block diagram showing an exemplary functional configuration of a core rate generation apparatus 1 according to the embodiment of the present invention.

FIG. 3 is a time-series graph illustrating an example in which pricing errors occur in the best rate calculation due to an anomalous fluctuation in the counterparty-presenting rate acquired from a plurality of counterparties.

FIG. 4 is a flowchart showing an exemplary outline processing procedure of a core rate generation processing carried out by the core rate generation apparatus according to the embodiment of the present invention.

FIG. 5 is a flowchart showing an exemplary detailed processing procedure of a weight calculation processing carried out in step S4 of FIG. 4.

FIG. 6 is a time-series graph comparing a core rate generated by the core rate generation apparatus 1 of the present embodiment with a conventional core rate calculated from the best rate.

FIG. 7 is a diagram showing an exemplary hardware configuration of the core rate generation apparatus 1 according to the embodiment of the present invention.

### DESCRIPTION OF EMBODIMENTS

Hereinafter, embodiments of the present invention will be described in detail with reference to the accompanying drawings. Among the constituent elements disclosed herein, those having the same function are denoted by the same reference numerals, and a description thereof is omitted. It should be noted that the embodiments disclosed herein are illustrative examples as means for implementing the present invention, and should be appropriately modified or changed depending on a configuration and various conditions of an apparatus to which the present invention is applied, and the present invention is not limited to the following embodiments. Furthermore, it should be noted that all of the combinations of features described in the following embodiments are not necessarily essential to the solution of the present invention.

Hereinafter, a non-limiting example will be described in which a rate generation apparatus according to the present embodiment generates a core rate that is a basis for deriving a rate to be presented to a customer (i.e., investor) in the FX (Foreign Exchange Margin Transactions). Nevertheless, the present embodiment is not limited thereto.

The rate generation apparatus according to the present embodiment may be applied to any transaction based on an exchange rate of a currency, such as a stock, a virtual currency, or a global point that can be converted into a plurality of currency values.

### <Network Configuration of FX Transaction System>

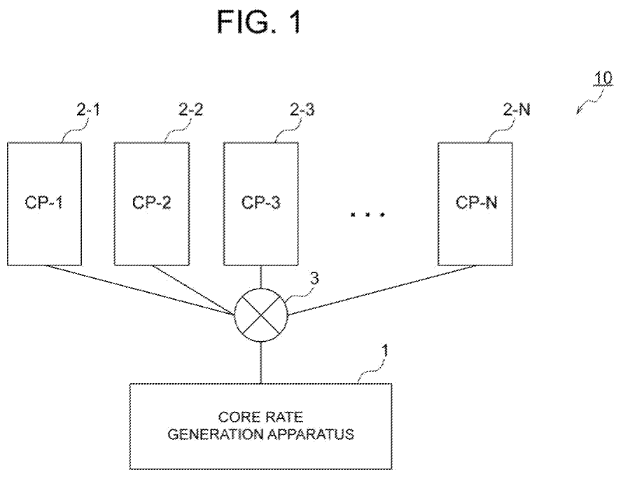

FIG. 1 is a block diagram showing an exemplary network configuration of an FX transaction system according to the present embodiment.

The FX transaction system 10 shown in FIG. 1 includes a core rate generation apparatus 1 and a plurality of counterparty apparatuses 2-1, 2-2, 2-3, . . . , 2-N. The core rate generation apparatus 1 is connected to a plurality of counterparty apparatuses 2-1, 2-2, 2-3, . . . , 2-N via a network 3 so as to be able to communicate with each other.

The core rate generation apparatus 1 is owned or otherwise accessibly managed by an FX operator and acquires counterparty-presenting rates which are presented from a plurality of counterparty apparatuses 2-1, 2-2, 2-3, . . . , 2-N at a constant frequency (e.g., 5 to 10 ms), respectively, and generates a core rate for deriving a rate to be presented to a customer (i.e., investor) based on the acquired to-be-presented rates.

The core rate generation apparatus 1 is also connected to a computer (not shown) of a customer (i.e., investor) via a network 3, transmits a to-be-presented rate to the customer, which is derived from the generated core rate to the customer's computer, and receives a trading order from the customer's computer to perform an FX transaction.

Counterparty apparatuses 2-1, 2-2, 2-3, . . . 2-N are owned or otherwise accessibly managed by a plurality of distinct counterparties (e.g., financial institutions such as banks, or securities companies) and present counterparty-presenting rates to the FX operator at a constant frequency. It should be noted that the core rate generation apparatus 1 may transmit a request message requesting any of the counterparty apparatuses 2-1, 2-2, 2-3, . . . , 2-N to transmit the counterparty-presenting rate of the counterparty. In this case, the counterparty apparatus 2-1, 2-2, 2-3, . . . , 2-N receiving the request message may transmit the counterparty-presenting rate to the core rate generation apparatus 1, and the core rate generation apparatus 1 may receive the counterparty-presenting rate transmitted so as to acquire the counterparty-presenting rates.

### <Functional Configuration of Core Rate Generation Apparatus 1>

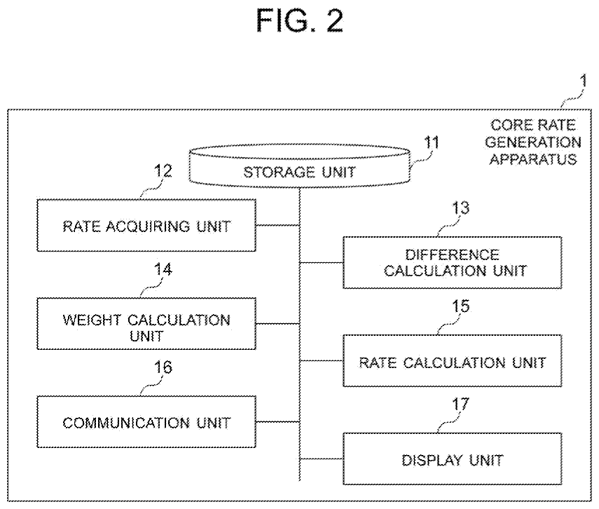

FIG. 2 is a block diagram showing an exemplary functional configuration of the core rate generation apparatus 1.

The core rate generation apparatus 1 illustrated in FIG. 2 includes a storage unit 11, a rate acquiring unit 12, a difference calculation unit 13, a weight calculation unit 14, a rate calculation unit IS, a communication unit 16, and a display unit 17.

The storage unit 11 may be configured with a volatile memory such as a Random Access Memory (RAM), a non-volatile memory such as a Read Only Memory (ROM), a Hard Disk Drive (HDD), a Solid State Drive (SSD), a removable external memory, or the like. The storage unit 11 is a storage area that can be shared and used by each of the components 12 to 17 in the core rate generation apparatus 1 through the system bus, and may be used as a storage for various types of data or a work memory.

The rate acquiring unit 12 acquires the counterparty-presenting rates from the counter parties, which are presented from the plurality of counterparty apparatuses 2-1, 2-2, 2-3, . . . , 2-N, respectively, at a constant frequency, via the communication unit 16, and sequentially stores the acquired counterparty-presenting rates from the counterparties in the storage unit 11 with time stamps and identifiers being added thereto, respectively.

The difference calculation unit 13 calculates a difference between an indicative (referential) counterparty-presenting rate, which is calculated for the entire 2-N of a plurality of counterparty apparatuses 2-1, 2-2, 2-3, . . . , 2-N, and a counterparty-presenting rate acquired from each of the counterparty apparatuses 2-1, 2-2, 2-3, . . . , 2-N as a variation (error) of each of the counterparty apparatuses 2-1, 2-2, 2-3, . . . , 2-N.

More particularly, the difference calculation unit 13 first calculates a mid value (i.e., mid rate) between the BID rate and the ASK rate of the counterparty-presenting rate of each counterparty acquired from each of the plurality of counterparty apparatuses 2-1, 2-2, 2-3, . . . , 2-N.

The difference calculation unit 13 also calculates a median value (i.e., median) of whole of the mid values calculated for the counterparty-presenting rates of all the counterparties acquired from all the counterparty apparatuses 2-1, 2-2, 2-3, . . . , 2-N, respectively, as the indicative (referential) counterparty-presenting rate.

The difference calculation unit 13 calculates the difference between the median value of the counterparty-presenting rates of all the counterparties calculated in this manner and the mid value of the counterparty presenting rates of each of the counterparties, and supplies the difference to the weight calculation unit 14.

It should be noted that the difference described in the present embodiment is by way of non-limiting example, and alternatively the difference calculated by the difference calculation unit 13 may be, for example, a difference between the counterparty-presenting rates of each of the counterparties and the median value of the counterparty-presenting rates of all the counterparties.

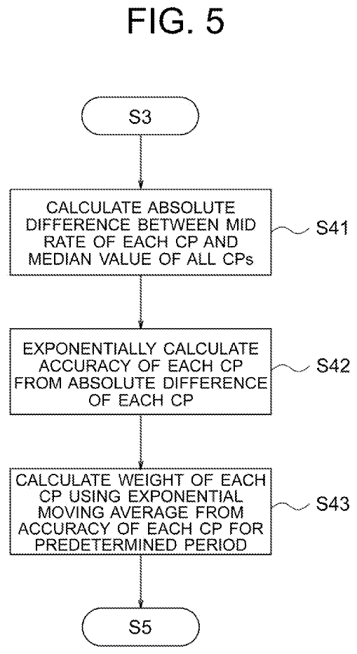

The weight calculation unit 14 calculates (derives) a weight for each of the counterparty apparatuses 2-1, 2-2, 2-3, . . . , 2-N based on the difference (error) calculated by the difference calculation unit 13. More particularly, the weight calculation unit 14 first calculates the accuracy (correctness) for each of the counterparty-presenting rates of the respective counterparty apparatuses 2-1, 2-2, 2-3, . . . , 2-N. Subsequently, the weight calculation unit 14 calculates a weight to be applied to each of the counterparties in the core rate calculation based on the accuracy calculated for each of the counterparties. The processing carried out by the weight calculation unit 14 will be described in detail hereinafter with reference to FIG. 5.

The rate calculation unit 15 generates a core rate using the counterparty-presenting rates of all the counterparty apparatuses 2-1, 2-2, 2-3, . . . , 2-N acquired by the rate acquiring unit 12, adds a predetermined spread to the generated core rate, applies a skew to the spread-added core rate, and calculates (generates) a to-be-presented rate to the investor, which is to be presented to the customer.

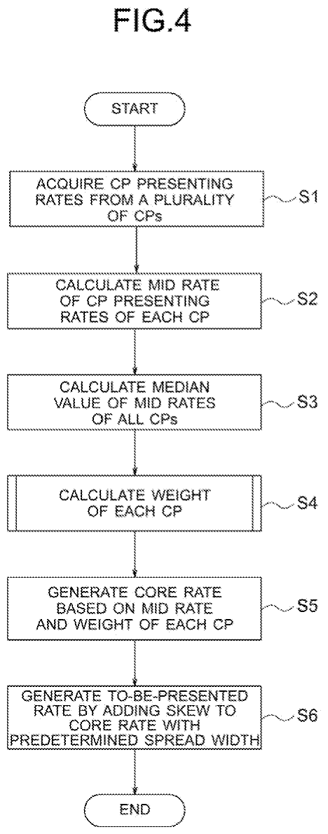

According to the present embodiment, the rate calculation unit 15 applies the weights calculated by the weight calculation unit 14 for respective counterparties with respect to the mid values of the counterparty-presenting rates of respective counterparty apparatuses 2-1, 2-2, 2-3, . . . , 2-N, and calculates the median value of the weighted mid values of respective counterparties so as to generate the core rate. The processing carried out by the rate calculation unit 15 will be described in detail hereinafter with reference to FIGS. 4 and 5.

The communication unit 16 provides an interface with the network 3 and performs communication with the counterparty apparatuses 2-1, 2-2, 2-3 . . . , 2-N and computer devices of clients through the network 3. According to the present embodiment, the communication unit 16 may perform communication via a wired Local Area Network (LAN) conforming to a communication standard such as Ethernet (registered trademark) or a dedicated line network. However, the network that can be used in the present embodiment is not limited to those and may be configured by a wireless network. The wireless network may include a wireless Personal Area Network (PAN) such as Bluetooth (registered trademark), ZigBee (registered trademark), and Ultra Wide Band (UWB). It may also include a wireless LAN such as Wi-Fi (Wireless Fidelity (registered trademark)) and a wireless Metropolitan Area Network (MAN) such as WiMAX (registered trademark). In addition, it may include a wireless Wide Area Network (WAN) such as LTE-3G, 4G, and 5G. It should be noted that any kind of network may be used as long as it may connect respective devices to each other so as to be able to communicate, and the standard, scale, and configuration thereof is not limited to those described above.

The display unit 17 displays and outputs the execution result of the core rate generation processing executed by the core rate generation apparatus 1 via a display device. The display unit 17 also provides a Graphical User Interface (GUI) for instructing and inputting, into the core rate generation apparatus 1, various parameters used in the core rate generation processing, communication parameters and the like.

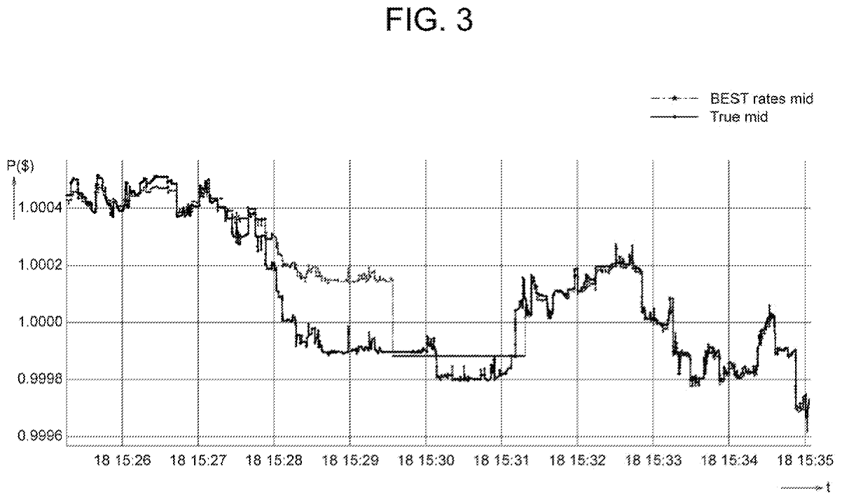

FIG. 3 is a time-series graph illustrating an example in which pricing errors occur in the best rate calculation due to anomalous fluctuations in the counterparty-presenting rate acquired from a plurality of counterparties.

Referring to FIG. 3, the solid line denotes true mid values in time series (i.e., mid values of the ASK rates and the BID rates), that is, a median value of a group of the mid values within the next time frame is plotted for each time point. On the other hand, the dashed-dotted line denotes mid values of the counterparty-presenting rates in time series extracted as the best rates among a subset of the counterparties manually selected from a plurality of counterparties as in the conventional art.

As shown in FIG. 3, up to 15:28 in time series, the best rate denoted by the dashed-dotted line follows the true mid value denoted by the solid line, but gradually deviates from the true mid value after 15:28, and the best rate freezes and becomes flat during the period from before 15:30 to after 15:31, and a pricing error occurs in which the best rate cannot be plotted.

In such an event, it would be considered that any of the counterparties obtains an inaccurate and anomalously fluctuating rate as the counterparty-presenting rate, and such an inaccurate and anomalously fluctuating rate incidentally becomes the best BID/ASK value, so that the best rate to be regarded as the core rate is directly affected by the anomalous fluctuating of the counterparty-presenting rate.

According to the present embodiment, in order to reduce the influence of such an anomalous fluctuating in the counterparty-presenting rate, the present embodiment generates the core rate from the counterparty-presenting rates of all the counterparties in consideration of the weight calculated based on the accuracy (correctness) of the counterparty-presenting rate of each of the counterparties.

### <Outline Processing Procedure of Core Rate Generation Processing>

FIG. 4 is a flowchart showing an exemplary outline processing procedure of the core rate generation processing executed by the core rate generation apparatus 1 according to the present embodiment.

It should be noted that each step shown in FIG. 4 may be carried out by the CPU reading and executing a program stored in the storage device of the core rate generation apparatus 1. Alternatively, at least a part of the flowchart shown in FIG. 4 may be carried out by a hardware. When implemented by the hardware, for example, by using a predetermined compiler, a dedicated circuit may be automatically generated on a Field Programmable Gate Array (FPGA) from programs for implementing the respective steps. Furthermore, a gate array circuitry may be formed in the same manner as the FPGA and implemented as the hardware. Yet furthermore, it may be implemented by an Application Specific Integrated Circuit (ASIC).

In step S1, the rate acquiring unit 12 of the core rate generation apparatus 1 acquires the counterparty-presenting rates from a plurality of counterparty apparatuses 2-1, 2-2, 2-3, . . . , 2-N, respectively, at a predetermined cycle. The counterparty-presenting rates acquired in step S1 may be transmitted from a plurality of counterparty apparatuses 2-1, 2-2, 2-3, . . . , 2-N through the network 3, or may be inputted via the storage unit 11.

In step S2, the difference calculation unit 13 of the core rate generation apparatus 1, which includes a mid value calculation unit, calculates a mid value (mid rate) of the counterparty presenting rates (ASK rate and BID rate) for each of counterparties acquired in step S1, as shown in Equation 1 below.

mid rate=(ASK rate+BID rate)/2 (Equation 1)

Alternatively, the core rate generation apparatus 1 may carry out the processing from steps S3 to S6 for the ASK rate and the BID rate of the counterparty-presenting rates, respectively, without calculating the mid value (mid rate) of the counterparty-presenting rates. In this case, the processing of step S2 in FIG. 4 may be omitted, and in the subsequent processing, either or both of the ASK rate and the BID rate may be set as the processing target instead of the mid value of the counterparty-presenting rates.

In step S3, the difference calculation unit 13 of the core rate generation apparatus 1, which includes a median value calculation unit, calculates the median value (median mid) of all of the mid values of the counterparty-presenting rates calculated in step S2.

It should be noted that the mid value calculation unit and the median value calculation unit may be included in the difference calculation unit 13, or the core rate generation apparatus 1 may include the mid value calculation unit and a median value calculation unit as different units from the difference calculation unit 13.

In step S4, the weight calculation unit 14 of the core rate generation apparatus 1 calculates the weights W to be applied to the counterparty-presenting rates of the counterparties, respectively, based on the mid values of the counterparty-presenting rates of the respective counterparties calculated in step S2 and the median value of the mid values of the counterparty-presenting rates of all the counterparties calculated in step S3, the details of which will be described hereinafter with reference to FIG. 5.

In step S5, the rate calculation unit 15 of the core rate generation apparatus 1 weights the mid values of all the counterparties at each time point t with the weights W calculated in step S4, respectively, and calculates the median value of the weighted mid values for all the counterparties as the core rate (house mid) as shown in Equation 2 below.

house mid_{t+Δt}=weighted median(wₜ, CP midₜ) (Equation 2)

It should be noted that A is a sampling interval and is, for example, 100 ms, but is not limited thereto.

In step S6, the rate calculation unit 15 of the core rate generation apparatus 1 adds a skew to the core rate calculated in step S5 with a predetermined spread width, and generates a to-be-presented rate to the investor, which is to be presented to the customer (i.e., investor). It should be noted that the spread width when adding the skew may be arbitrarily determined.

### <Weight Calculation Processing Details for Each Counterparty>

FIG. 5 is a flowchart showing an exemplary detailed processing procedure of the calculation processing of the weight W of each of counterparties, which is carried out by the weight calculation unit 14 of the core rate generation apparatus 1 in step S4 of FIG. 4.

In step S41, the weight calculation unit 14 of the core rate generation apparatus 1 calculates an error e from the true median value (true mid) of each counterparty at each time point t as shown in Equation 3 below.

ϵₜ^{j}=|CP mid_{{t-Δt}}^{j}−median midₜ| (Equation 3)

As shown in Equation 3, the error F of each counterparty is calculated as the difference (absolute difference) between the mid value (CP mid) of the counterparty-presenting rate of each counterparty calculated in step S2 of FIG. 4 and the median value (median mid) of the mid values of the counterparty-presenting rates of all counterparties at each time point t.

In step S42, the weight calculation unit 14 of the core rate generation apparatus 1 inputs the error ε of each counterparty calculated in step S41 to an exponential function below, and calculates the accuracy (correctness) of each counterparty at each time t (CPⱼ; j={1, . . . , N}) as shown in following Equation 4.

accⱼ^{t}=exp(−λϵₜ^{j}) (Equation 4)

As apparent from Equation 4, as the value of the error c of the counterparty CP increases, the accuracy acc of the counterparty CP decreases exponentially.

Furthermore, as the value of an adjustment parameter A increases, the accuracy acc decreases more rapidly. The accuracy acc calculated in step S42 takes a value between 0 and 1, and the closer acc is to 0, the larger the value of the error c, indicating that it is not useful for calculating the core rate. On the other hand, the closer acc is to 1, the smaller the value of the error c is, indicating that it is useful for calculating the core rate. In other words, by using the error c of each counterparty CP as an input to the exponential function of Equation 4, the error c is exponentially penalized.

By calculating the accuracy acc of each counterparty as in Equation 4, it makes it possible to reduce as much as possible the influence of the counterparty-presenting rate of the counterparty in which the anomalous fluctuation or the like has occurred so as to achieve the core rate generation with higher robustness against the anomalous fluctuation.

In step S43, the weight calculation unit 14 of the core rate generation apparatus 1 calculates the exponentially smoothed moving average (exponential moving average: ema) of a plurality of values of the accuracy acc of each counterparty CP calculated in step S42 for a predetermined period, thereby calculating the weight W of each counterparty CP at each time point t as in shown the following Equation 5.

wₜ^{j}=ema(η,acc_{{1:t}}^{j}) (Equation 5)

As the exponentially smoothed moving average function ema is applied to the accuracy acc of each counterparty CP, it makes it possible to exponentially reduce the weight on the accuracy acc at a past point in time to calculate the average value of a plurality of values of the accuracy acc. In other words, since the latest accuracy acc is doubled and the latest accuracy acc therefore weighs heavily, it makes it possible to increase the data freshness of the calculated weight W.

The weight calculation unit 14 performs weighting with the weight W for each counterparty CP calculated in step S43. The rate calculation unit 15, in step S5 of FIG. 4, calculates (generates), as the core rate at time point t, the median value (median mid) of the mid values of the counterparty-presenting rates of all counterparties at time point t.

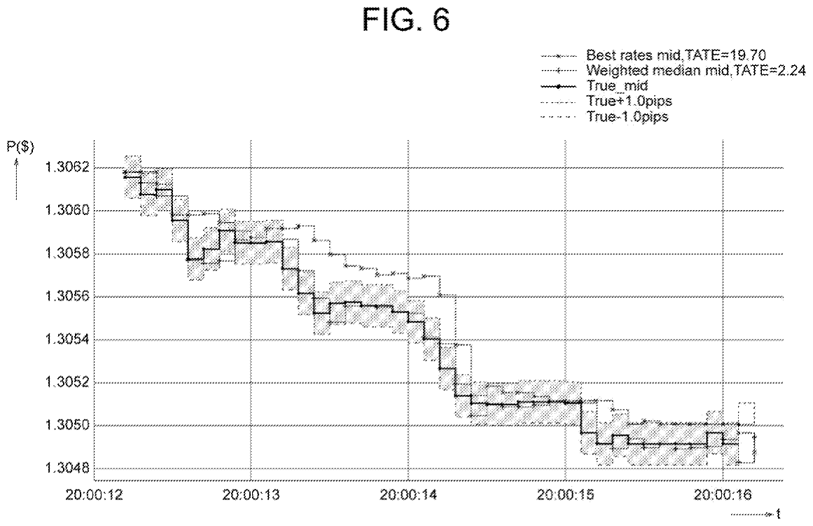

FIG. 6 is a time-series graph comparing the core rate generated by the core rate generation apparatus 1 according to the present embodiment with a core rate calculated from the best rate in the conventional art.

Referring to FIG. 6, the solid line (bold line) denotes the time-series transition of the true mid values (True_mid) of the counterparty-presenting rates of a plurality of counterparties in a pair of currencies of the British pounds/U.S. dollars (GBP/USD).

The dashed-dotted line in FIG. 6 denotes the time-series transition of the core rate (best rates mid) calculated from the best rate in a conventional art. It can be observed that the core rate calculated by the conventional best rate method deviates from the range of +/−1 pips of the true mid values (True-mid) of the counterparty-presenting rates at many time points.

On the other hand, the solid line (thin line) in FIG. 6 denotes the core rate (weighted median mid) generated by the core rate generation apparatus 1 according to the present embodiment. It can be recognized that the core rate according to the present embodiment sufficiently follows the true mid values of the counterparty-presenting rates (True_mid) within the range of +/−1 pips of the true mid values of the counterparty-presenting rates (True_mid) over the observational period in FIG. 6.

Total Absolute Thresholded Error (TATE) shown in the upper right of FIG. 6 is represented by the following Equation 6, which can be used as an evaluation function for the core rate.

$$TATE = {\sum }_{t} [ max ( 0 , \vert \frac{( {t}_{} - {mid}_{t}^{true} )}{pip} \vert - 1 ) ] \qquad ( Equation 6 )$$

Here,

[symbol]

ₜ denotes the value of the core rate generated by the core rate generation apparatus 1 according to the present embodiment calculated using the data up to the time point t−Δt, and
midₜ^{true} denotes the median value of the mid values of the true counterparty-presenting rates at time point t.

The smaller the value of TATE, the closer to the true value and the higher the accuracy, and the larger the value of TATE, the more deviated from the true value and the lower the accuracy. The parameter η of the weighting calculation and the parameter λ of the accuracy (correctness) calculation can be optimized using the machine learning or the like by repeatedly training and adjusting those parameters η and λ such that the values of TATE become lower by inputting data for a predetermined period (e.g., 10 days).

### <Hardware Configuration of Core Rate Generation Apparatus 1>

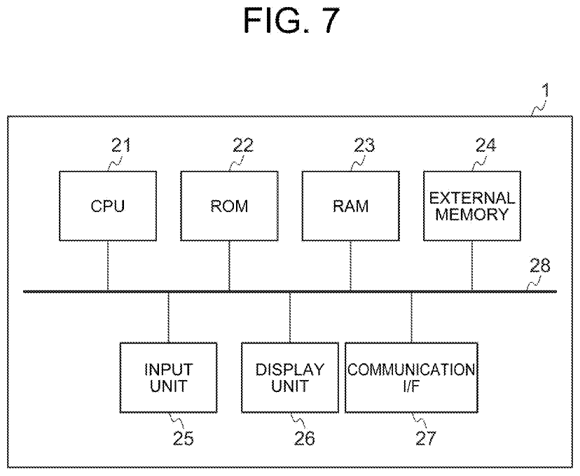

FIG. 7 is a diagram showing an exemplary hardware configuration of the core rate generation apparatus 1 according to the present embodiment.

The core rate generation apparatus 1 according to the present embodiment can be implemented on any one or more computers, mobile devices, or any other processing platform.

As shown in FIG. 7, the core rate generation apparatus 1 includes a CPU 21, a ROM 22, a RAM 23, an external memory 24, an input unit 25, a display unit 26, a communication O/F 27, and a system bus 28.

The CPU 21 controls operations of the core rate generation apparatus 1 in an integrated manner and controls the components (22 to 27) via a system bus 28. The ROM 22 is a non-volatile memory that stores a control program or the like required for CPU 21 to execute the processing. Instead, the program may be stored in the external memory 24 or a removable storage medium (not shown). The RAM 23 functions as a main memory or a work area or the like for the CPU 21. In other words, the CPU 21 loads a required program or the like from the ROM 22 into the RAM 23 at the time of executing the processes and executes the program or the like to realize various functional operations.

The external memory 24 stores, for example, various data and various information required when the CPU 21 executes a process using a program. Furthermore, the external memory 24 stores, for example, various data and various information obtained by the CPU 21 performing a process using a program or the like. The input unit 25 is constituted with a keyboard or a pointing device such as a mouse. The display unit 26 serving as a display device is constituted with a monitor such as a liquid crystal display (LCD). The communication L/F 27 is an interface for controlling communication between the core rate generation apparatus 1 and the counterparty apparatuses 2-1, 2-2, 2-3, . . . , 2-N or the computer devices of the clients.

Functions of at least some of the elements of the core rate generation apparatus 1 shown in FIG. 2 can be realized by the CPU 21 executing programs. Nevertheless, at least a part of the functions of the elements of the core rate generation apparatus 1 shown in FIG. 2 may operate as a dedicated hardware. In this case, the dedicated hardware operates based on the control of the CPU 21.

The counterparty apparatuses 2-1, 2-2, 2-3, . . . , 2-N shown in FIG. 1 can also be realized with the similar hardware configuration.

As described above, according to the present embodiment, the core rate generation apparatus calculates, for each of the plurality of counterparties, a difference (error) between the mid value calculated for the rates of each of the plurality of counterparties and the median value of whole of the mid values of the plurality of counterparties, and derives a weight for each of a plurality of counterparties based on the calculated difference. The core rate generation apparatus further applies the weight to the calculated mid value for each of the plurality of counterparties to generate a core rate.

As a result, according to the present embodiment, it makes it possible to generate a core rate more accurately that is robust against an anomalous fluctuation incidentally occurring in the rate presented by a plurality of counterparties.

Although specific embodiments have been described above, the embodiments described are illustrative only and are not intended to limit the scope of the present invention. The apparatus and method described herein may be embodied in other forms than as described above. In addition, it is also possible to appropriately omit, substitute, or modify the above described embodiments without departing from the scope of the present invention. Embodiments with such omissions, substitutions and modifications fall within the scope of the appended claims and equivalents thereof and also fall within the technical scope of the present invention.

### REFERENCE SIGNS LIST

1: Core Rate Generation Apparatus; 2: Counterparty Apparatus; 3: Network; 11: Storage Unit; 12: Rate Acquiring Unit; 13: Difference Calculation Unit; 14: Weight Calculation Unit; 15: Rate Calculation Unit; 16: Communication Unit; 17: Display Unit; 21: CPU; 22: ROM; 23: RAM; 24: External Memory; 25: Input Unit; 26: Display Unit; 27: Communication I/F; 28: System Bus

1. A core rate generating apparatus, comprising:
at least one memory configured to store program code;
electronic circuitry including at least one of an Application Specific Integrated Circuit (ASIC), a Field Programmable Gate Array (FPGA), and at least one processor, the processor being configured to operate as instructed by the program code, the electronic circuitry configured to;
acquire a plurality of rates respectively generated by a plurality of counterparties;
calculate a median value of whole of the plurality of rates of the plurality of counterparties;
calculate a first difference between each of the plurality of rates and the median value for each of the plurality of counterparties;
derive, based on the first difference, a weight for each of the plurality of counterparties; and
apply, for each of the plurality of counterparties, the weight to each of the rates and generate, as a core rate, a median value of whole of weighted rates of the plurality of counterparties.

2. The core rate generation apparatus according to claim 1, wherein the electronic circuitry is further configured to:
calculate a mid value of the plurality of rates for each of the plurality of counterparties, and
calculate the median value of whole of the mid values of the plurality of counterparties,
calculate a second difference between the mid value and the median value for each of the plurality of counterparties, and
apply, for each of the plurality of counterparties, the weight to the mid value to generate the core rate.

3. (canceled)

4. The core rate generation apparatus according to claim 2, wherein the electronic circuitry is further configured to:
calculate an accuracy value of each of the plurality of counterparties using the second difference between the mid value and the median value as an input to an exponential function, and derive the weight from the accuracy value calculated.

5. The core rate generation apparatus according to claim 4, wherein the electronic circuitry is further configured to:
calculate the accuracy value of each of the plurality of counterparties over a predetermined period, and derive the weight based on a plurality of accuracy values calculated.

6. The core rate generation apparatus according to claim 5, wherein the electronic circuitry is further configured to:
derive the weight by calculating an exponential moving average of the plurality of the accuracy values calculated over the predetermined period.

7. The core rate generation apparatus according to claim 6, wherein the electronic circuitry is further configured to:
adjust a first parameter of the exponential moving average using a predetermined evaluation function when deriving the weight from the accuracy values.

8. The core rate generation apparatus according to claim 4, wherein the electronic circuitry is further configured to:
adjust a second parameter of the exponential function using a predetermined evaluation function when calculating the accuracy value using the second difference as an input to the exponential function.

9. The core rate generation apparatus according to claim 1, wherein the electronic circuitry further is further configured to:
generate a rate to be presented to a customer by adding a skew to the generated core rate with a predetermined spread width.

10. A core rate generation method executed by a core rate generation apparatus, comprising:
acquiring a plurality of rates respectively generated by a plurality of counterparties;
calculating a median value of whole of the plurality of rates of the plurality of counterparties;
calculating a first difference between each of the plurality of rates and the median value for each of the plurality of counterparties;
deriving, based on the first difference, a weight for each of the plurality of counterparties; and
applying, for each of the plurality of counterparties, the weight to each of the rates and generating, as a core rate, a median value of whole of weighted rates of the plurality of counterparties.

11. A non-transitory computer readable medium having stored thereon, a program product for causing a computer to function as respective components of the core rate generation apparatus according to claim 1.

12. A core rate generating apparatus, comprising:
at least one memory configured to store program code;
electronic circuitry including at least one of an Application Specific Integrated Circuit (ASIC), a Field Programmable Gate Array (FPGA), and at least one processor, the processor being configured to operate as instructed by the program code, the electronic circuitry configured to:
acquire a plurality of rates respectively generated by a plurality of counterparties;
calculate a median value of whole of the plurality of rates of the plurality of counterparties;
calculate a first difference between each of the plurality of rates and the median value for each of the plurality of counterparties;
calculate an accuracy value of each of the plurality of counterparties over a predetermined period using the first difference as an input to an exponential function, calculate an exponential moving average of a plurality of the accuracy values calculated, and derive a weight for each of the plurality of counterparties; and
apply, for each of the plurality of counterparties, the weight to each of the rates and generate a core rate.

13. The core rate generation apparatus according to claim 12, wherein the electronic circuitry is further configured to:
calculate a mid value of the plurality of rates for each of the plurality of counterparties,
calculate the median value of whole of the mid values of the plurality of counterparties,
calculate a second difference between the mid value and the median value for each of the plurality of counterparties, and
apply, for each of the plurality of counterparties, the weight to the mid value to generate the core rate.

14. The core rate generation apparatus according to claim 13, wherein the electronic circuitry is further configured to:
generate, as the core value, a median value of whole of a plurality of weighted mid values of the plurality of counterparties.

15. The core rate generation apparatus according to claim 12, wherein the electronic circuitry is further configured to:
adjust a first parameter of the exponential moving average using a predetermined evaluation function when deriving the weight from the accuracy values.

16. The core rate generation apparatus according to claim 12, wherein the electronic circuitry is further configured to:
adjust a second parameter of the exponential function using a predetermined evaluation function when calculating the accuracy value using the second difference as an input to the exponential function.

17. The core rate generation apparatus according to claim 12, wherein the electronic circuitry is further configured to:
generate a rate to be presented to a customer by adding a skew to the generated core rate with a predetermined spread width.

18. A core rate generating method executed by a core rate generation apparatus, comprising:
acquiring a plurality of rates respectively generated by a plurality of counterparties;
calculating a median value of whole of the plurality of rates of the plurality of counterparties;
calculating a first difference between each of the plurality of rates and the median value for each of the plurality of counterparties;
calculating an accuracy value of each of the plurality of counterparties over a predetermined period using the first difference as an input of an exponential function, calculating an exponential moving average of a plurality of the accuracy values calculated, and deriving a weight for each of the plurality of counterparties; and
applying, for each of the plurality of counterparties, the weight to each of the rates and generating a core rate.

19. A non-transitory computer readable medium having stored thereon a computer program product configured to cause a computer to operate as respective components of the core rate generation apparatus according to claim 12.
